(19) United States
(12) Patent Application Publication
(10) Pub. No.: US 2012/0239612 A1
(43) Pub. Date: Sep. 20, 2012

(54) USER DEFINED FUNCTIONS FOR DATA LOADING

(76) Inventors: Muthian George, Fremont, CA (US); Song Wang, Mountain View, CA (US)

(21) Appl. No.: 13/485,246

(22) Filed: May 31, 2012

Related U.S. Application Data
(63) Continuation-in-part of application No. 13/240,582, filed on Sep. 22, 2011.
Application No. 13/240,582 is a continuation-in-part of application No. PCT/US11/22437, filed on Jan. 25, 2011.

(51) Int. Cl. G06F 17/30

(52) U.S. Cl. 707/602; 707/E17.005

(57) ABSTRACT

Data loading with user defined functions is described in various implementations. An example system for data loading may include a structured query language (SQL) compiler to identify a call to a table valued user defined function (TVUDF) within a SQL statement that includes an insert statement; identify metadata associated with the TVUDF; validate and resolve a subclass type of the TVUDF based on the metadata and the insert statement; and generate a data loading plan to retrieve and load data from an external data source into a table of a database based on the subclass type of the TVUDF. The system may also include a data loading engine in the database to execute the data loading plan, the data loading plan including the TVUDF to retrieve data from the external data source, and load the retrieved data into the table of the database in accordance with the data loading plan.

### CROSS-REFERENCE TO RELATED APPLICATIONS

This application is a continuation-in-part of application Ser. No. 13/240,582, filed Sep. 22, 2011, which is a continuation-in-part of International Application No. PCT/US11/22437, filed Jan. 25, 2011, both of which are hereby incorporated by reference.

### BACKGROUND

Analytical data processing systems consume tables of data which are typically linked together by relationships in databases that simplify the storage of data and make queries of the data more efficient. A standardized query language, such as Structured Query Language (SQL), may be used for creating and operating on relational databases.

Data may be loaded into relational databases using a number of different approaches. For example, some database vendors supply data loading software utilities that use standard application programming interfaces (APIs), such as Open Database Connectivity (ODBC) or Java Database Connectivity (JDBC), for loading data into the databases. Often, such data loading utilities use SQL INSERT statements to load data supplied in Comma Separated Value (CSV) text data format, where each row of data is expressed in a line of text with the various fields separated by comma, tab, or a user-defined field separating character.

### BRIEF DESCRIPTION OF THE DRAWINGS

FIG. 1 illustrates an example of a data processing system having integrated table valued user defined functions for data loading.

FIG. 2 illustrates another example of a data processing system having integrated table valued user defined functions for data loading.

FIG. 3 illustrates an example process for data loading with a table valued user defined function.

FIG. 4 is a schematic block diagram illustrating an example system of hardware components capable of implementing examples of the systems and methods for data loading with table valued user defined functions illustrated in FIGS. 1-3

### DETAILED DESCRIPTION

Loading data into databases is an important process, particularly when the databases are to remain online for application services during data loading. When the datasets to be loaded are relatively large, data loading may consume a significant amount of computing resources for portions of or all of the duration of the loading process.

Database vendors typically supply data loading software utilities for loading data into their databases. These data loading utilities may use input files, such as CSV files, as the input data source for loading data. The data loading utilities may load rows of data one at a time or in multiple now bulk buffers using a number of different approaches. For example, in one approach, the data loading utility may prepare each row of input data as VALUES embedded in an INSERT statement. In another approach, database APIs such as ODBC and JDBC can be used for loading a number of rows in a bulk buffer for each INSERT statement execution. This process of executing the INSERT statement may be repeated with new rows populated in the bound bulk buffer until all the rows are inserted. In yet another approach, database vendors may supply native database loading software utilities for loading data in bulk from input files. In this approach, the native database loading utilities may bypass the regular SQL statement compilation and execution pathways, and may instead insert rows directly into the database table pages. This approach may not be available for implementation in a general purpose data loading software utility because the transaction integrity management functionality and the row structures are not exposed by the databases for building general purpose data loading utilities.

In many of the data loading utilities described above, input data rows are assumed to reside in source files in a well-defined format that the data loading utility can understand. For this to occur, the data may first have to be retrieved from an external data source, then transformed and/or cleansed, and then stored in a source file in the format known to the loading utility (e.g., CSV text data format). Then, after the data are ready in one or more source files, the data may be read from the source files and loaded into the database tables using one or more of the data loading approaches described above. Thus, a typical data loading process may utilize multiple steps of processing involving an external data source, client software for retrieving and storing the data in a source file, and, finally, a data loading utility to read the data from the source files and load the rows in database tables. This may involve significant computing and storage resources, as well as the movement of data through a network at least twice (e.g., first, at the time of preparing the input file from the external data source, and second, at the time of loading the data into database tables). To ensure data governance and security requirements, the entire process may be performed in a secure environment, which may result in additional operational cost for data loading, and may also cause delays in data loading.

In accordance with the techniques described herein, a different data loading approach may utilize table valued user defined functions (TFUDFs) for loading data directly from an external data source into database tables using standard SQL statements. TVUDFs may be used in the FROM clause of a SELECT SQL statement for retrieving data directly from external data sources, and the rows thus retrieved are used in the internal processing of a database SQL statement. As such, certain steps (e.g., storing retrieved data in a file, transferring data twice through a network, etc.) may be eliminated.

In one example implementation of the techniques described herein, a system for data loading may include a structured query language (SQL) compiler and a data loading engine. The SQL compiler may identify a call to a TVUDF within a SQL statement that includes an insert statement. Each TVUDF may have associated metadata that describes the input, output, and parameter fields and the class and/or subclass type (described later) of the TVUDF. The SQL compiler may identify the metadata of the TVUDF in the insert statement, validate and resolve the subclass type of the TVUDF based on the metadata and the insert statement, and generate a data loading plan to retrieve and load data from an external data source into a table of a loading database based on the subclass type of the TVUDF. The data loading engine may execute the data loading plan, the data loading plan including the TVUDF to retrieve data from the external data source, and load the retrieved data into the table of the loading database in accordance with the data loading plan.

TVUDFs are generally characterized by their generation of output rows with key or dimension fields in addition to measure and other descriptive fields. TVUDFs may be used in the FROM clause of a SELECT SQL statement, similar to a table where the table of rows it returns participates as a source table in relational set processing operations.

As will be described in greater detail below, four different subclass types of TVUDFs may be provided for data loading purposes in accordance with the techniques described herein. The four subclass types may be classified into two groups of two subclass types each. The first two subclass types, TVUDFRegular and TVUDFPage, may be considered on-demand TVUDFs. These on-demand subclass types may be used in INSERT statements by a client program and executed in a database for retrieving data from external data sources for on-demand data loading. When on-demand TVUDFs finish retrieving data from the external data sources, data loading comes to an end, and the INSERT statement returns. The second two subclass types, CLTVUDFRegular and CLTVUDFPage, may be designed for use in a continuously data loading INSERT statement. This group of continuously data loading TVUDFs may generally be referred to herein as CLTVUDFs. The CLTVUDF subclass types may be used with extended syntax of INSERT statements and executed in a database as one or more background processes for loading data from external data sources that may continuously send data.

The subclass types that and with Regular (TVUDFRegular and CLTVUDFRegular) return one row of data at a time to an executor for processing until the end of the input rows has been reached. The subclass types that end with Page (TVUDFPage and CLTVUDFPage) return a page of rows to the executor for processing.

The different subclass types a SQL compiler to understand the type of processing that is to occur, such that the SQL compiler can generate an appropriate data processing plan. The subclass types may be derived from the TVUDF class type enumeration by bit OR processing with the subclass type identifier, thus making the subclass type unique as well as the TVUDF class type. The SQL compiler may use the TVUDF subclass type to generate the appropriate data processing plan, and a data loading engine may execute the plan to return rows from the TVUDF, e.g., in a SQL statement. The SQL compiler may use the TVUDF class type to validate its use in the FROM clause of a SQL SELECT statement. The four TVUDF subclass types, and example implementations using these subclass types, are described in greater detail below.

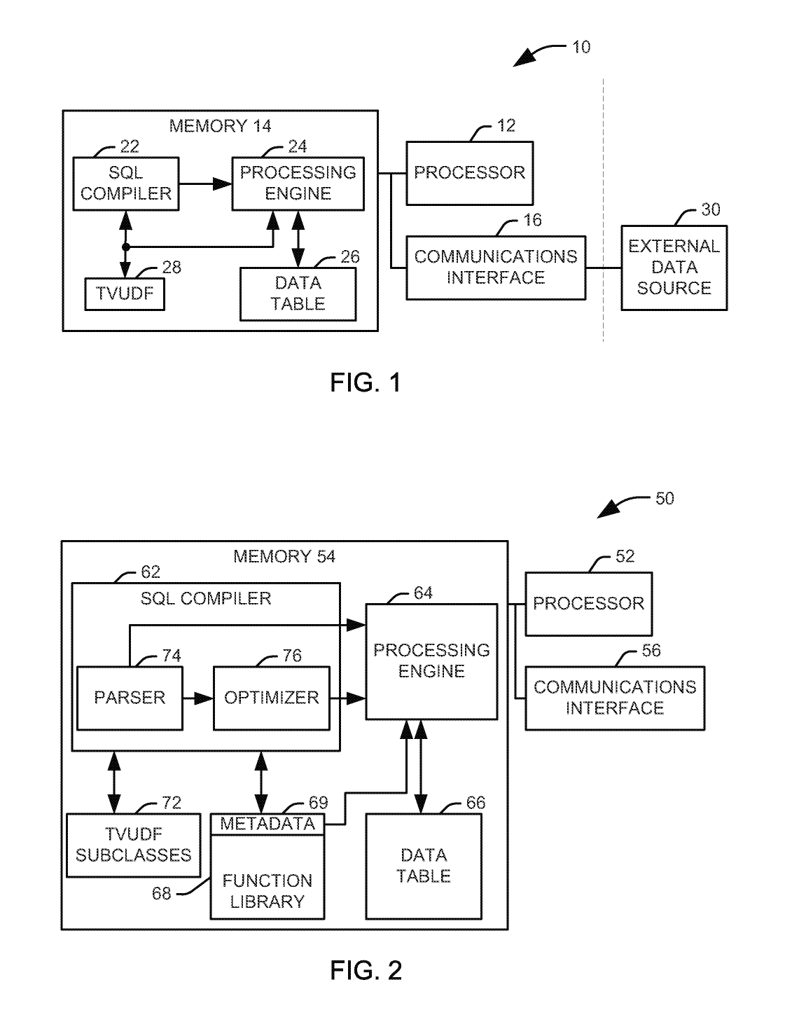

FIG. 1 illustrates an example of a data processing system 10 having an integrated table valued user defined functions (TVUDFs 28) for data loading. The TVUDFs 28 may be organized according to predefined function subclass types. The data processing system 10 of FIG. 1 can represent a database system, a data warehouse, a data mart, an in-memory database, a standalone analytics engine, a business intelligence report generation system, a data mining system, a federated query processing system, or the like.

The data processing system 10 includes a processor 12 and a memory 14 connected to a communications interface 16. The communications interface 16 is connected to an external data source 30, which may represent any appropriate source of data that is external to, but accessible by, the data processing system 10. External data source 30 may include structured or unstructured sources of data. While processing unstructured external data sources, the TVUDF may convert the unstructured data into appropriate structured rows of data consisting of one or more fields similar to rows in the database tables.

In some implementations, the memory 14 can be a removable memory, connected to the processor 12 and the communications interface 16 through an appropriate port or drive, such as an optical drive, a USB port, or other appropriate interface. Further, the memory 14 can be remote from the processor 12, with machine readable instructions stored on the memory provided to the processor via a communications link. In some implementations, multiple processors may be used, as appropriate, along with multiple memories and/or different or similar types of memory.

The communication interface 16 can comprise any appropriate hardware and machine readable instructions for accessing the external data source 30 and returning the results of such access to various components of the data processing system 10. Communications interface 16 may also be configured to receive queries from an associated query source (not shown) and return the results of the queries to the query source. The communications interface 16 can include any or all of a bus or similar data connection within a computer system or a wired or wireless network adapter.

The memory 14 can include a SQL compiler 22, a processing engine 24 to compile and execute an insert statement to bad data in a data table 26 using a table valued user defined function (TVUDF). The SQL compiler 22 can utilize any appropriate language, such as Structured Query Language (SQL) or multidimensional expression (MDX) language, or any appropriate procedural language while loading data into a database table. In some implementations, the TVUDFs 28 may be stored as shared objects or as dynamic link libraries. The TVUDFs 28 may also include exposed metadata that defines an associated class type and/or subclass type of the function. The class type and/or subclass type of the TVUDF 28 may also define one or more properties of the function, such as an associated processing scenario of the function and/or appropriate usage semantics of the table valued user defined function in an insert statement. By grouping the TVUDFs 28 into predetermined function class types and subclass types, the various properties can be efficiently stored in the metadata and conveyed to the SQL compiler 22 or to other components of the data processing system 10.

In general, the functional components 22, 24, 26, and/or 28, may each be implemented as any appropriate combination of hardware and/or programming configured to perform their associated functions. For example, each of the SQL compiler 22, the processing engine 24, the data table 26, and the TVUDFs 28 may include machine readable instructions stored on a non-transitory medium and executed by an associated processor, but it will be appreciated that other implementations of the functional components, for example, as dedicated hardware or as a combination of hardware and machine readable instructions, could be used.

In operation, the SQL compiler 22 may identify a call to a TVUDF within a query that includes an insert statement, and may identify metadata associated with the TVUDF. Using this information, the SQL compiler 22 may validate and resolve a subclass type of the TVUDF, and may generate a data loading plan to retrieve and load data from the external data source 30. Processing engine 24 may execute the TVUDF to retrieve data from the external data source 30, and may load the retrieved data into the appropriate data table 26 in accordance with the data loading plan.

FIG. 2 illustrates another example of a data processing system having integrated table valued user defined functions for data loading. Specifically, the data processing system is implemented as a database system 50, with table valued user defined functions (TVUDFs) integrated into a SQL processing framework. It should be appreciated, however, that the TVUDF class and subclass types described herein are not specific to a particular SQL processing framework or to any particular data processing framework. Rather, a similar use of TVUDFs for data loading could be implemented in other appropriate data processing systems.

The database system 50 includes a processor 52 and a memory 54 connected to a communications interface 56. It will be appreciated that the communication interface 56 can comprise any appropriate hardware and machine readable instructions for accessing an external data source and returning the results of such access to various components of the database system 50. Accordingly, the communications interface 56 can include any or all of a bus or similar data connection within a computer system or a wired or wireless network adapter. The memory 54 can include any set of one or more operatively connected storage devices appropriate for use with computer systems, such as magnetic and optical storage media. In some implementations, multiple processors may be used, as appropriate, along with multiple memories and/or different or similar types of memory.

The memory 54 can include a SQL compiler 62 and a processing engine 64 to compile and execute insert statements on a data table 66. The SQL compiler 62 includes a parser 74 and an optimizer 76. The compiler 62 can identify a call to a user defined function within the insert statement, determine its class and subclass type from its associated metadata 69, and validate the semantic correctness of its syntactic specification in the insert statement. The compiler 62 may process a call to a TVUDF within an insert statement using a standardized UDF syntax to distinctly map output and parameter expressions to appropriate objects. Note that TVUDFs are characterized by the absence of input arguments and therefore, they do not have input field metadata in their metadata. The compiler 62 structures these output fields into a self-describing table object with field names, data types, and data sizes to standardize processing of the user defined function class and subclass types.

In some implementations, the TVUDFs are built in a UDF library 68, for example as shared objects or dynamic link libraries, and registered with the processing engine 64. Each shared object exposes the user defined functions in the form of self-describing UDF metadata 69 that can be retrieved by the SQL compiler 62. The UDF metadata 69 can include, for example, a name of the user defined function, a description, an associated class and/or subclass type, a factory constructor function pointer to create a runtime processing object instance, a function pointer for the validation and resolution of input, output, and parameters, and other runtime optimization parameters, as well as defined input, output, and parameter fields for the function. The SQL compiler 62 accesses these fields for UDF resolution and validation in the SQL statement. A general purpose function supplied with the system can be used to validate input, output, and parameter fields to resolve their data types and lengths at the SQL compiler 62 when an explicit validation and resolution function is not supplied by the user defined function as a function pointer in the metadata 69.

The metadata 69 for each TVUDF can include an associated class and subclass type according to any of the four TVUDF subclass types 72 to assist in the usage validation and optimization of the SQL statement. The user defined function class and subclass types may implicitly set the rules for data processing in the processing engine 64. In addition to the class and subclass type, the metadata 69 for each function can indicate an associated processing scenario. Specifically, it can be indicated whether the function will process one row of data at a time or a page of data at a time (e.g., Regular versus Page); whether the function will execute in an on-demand manner or in a continuous manner (e.g., TVUDF versus CLTVUDF); whether an identification number from the SQL compiler is to be used for the function to obtain a configuration resource to process different data partitions; whether the function retrieves the external data in sorted order; whether the function executes in the data storage computer node; and the like.

Each of the TVUDF class and subclass types may be used to connect to external data sources and retrieve a table of rows in the FROM clause of a SQL query. When a TVUDF returns a table in the FROM clause along with other tables, the TVUDF table rows are processed further in the SQL set processing nodes similar to multiple table processing SQL queries. It will be appreciated, however, that a TVUDF does not need to be in the FROM clause when databases support SQL queries without a FROM clause. In such cases, a TVUDF can be used directly in the projection list of a SQL query as a standalone query or a sub-query without a FROM clause. When occurring in the projection list, the TVUDF is treated as a singleton UDF.

TVUDFs are defined without any input arguments. TVUDFs may be used in the FROM clause of a query or as a singleton TVUDF sub-query to return a table of rows from external data sources into the query for further processing. Thus, the TVUDFs are linked to the FROM clause of a query returning a table of rows. The external data source can be a structured or unstructured data source. Each TVUDF knows the type of the external data source, obtains access to the external source using the supplied parameters and retrieves the table of rows from the external data sources. When external data sources are databases, the TVUDF is supplied with a parameter having a query for processing in the external database. In such cases, the TVUDF retrieves the query for the external database from the given parameter and sends the query to the external source database for processing and returning a table of structured rows.

In the case of unstructured data sources, TVUDFs may process the unstructured data and extract a table of rows. In such cases, TVUDFs exhibit the characteristics of mapping functions in map/reduce processing systems. Mapping functions, in general, are defined to convert unstructured data into key/value pairs where key and value may include multiple fields. In structured systems, tables consist of a number of dimension and value fields which are similar to key/value pairs of map/reduce systems. External unstructured data sources can include data files, live data streams (e.g., from the stock market), sensors, web pages, or other systems that manage unstructured data sources. For each such external data source, a separate TVUDF can be used for table extraction. TVUDFs can be combined with INSERT statements, as described herein, for data retrieval from external sources and loading the rows into the database.

In the case of structured data sources, TVUDFs either pick up a table of rows residing in some data source repository directly or return a table of rows resulting from the processing of queries in the external structured data sources. External structured data sources can include structured record files, spreadsheets, databases, or any other appropriate structured row-supplying or processing system that returns a table of rows with or without a query. Record files can be of different kinds such as comma separated value (CSV) files, fixed text, or binary data files containing a table of rows. As with the unstructured data sources, a separate TVUDF can be used for table extraction from each structured data source.

The compiler 62 can review the input SQL statement to ensure that the call to the user defined function is valid. To this end, the compiler 62 can retrieve the associated class and subclass type of each TVUDF from the metadata 69 and apply a set of logical rules to the SQL statement to evaluate the validity of each function call. For example, if a TVUDF is included in a query outside the context of a FROM clause of a SELECT statement or an INSERT statement with extended syntax as described below, the SQL compiler 62 may return an error.

For data loading, TVUDFs may be used in a SQL INSERT/SELECT statement as in the following example:

INSERT INTO sales (orderId, productId, salesDate , countItems,
salesValuePerItem)
SELECT S.orderId, P.productId, S.salesDate , S.countItems,
S.valuePerItem
FROM products P, (ODBCQueryReader( ) OUTPUT(orderId,
productName, salesDate , countItems, valuePerItem) WITH
PARAMETER(ODBC_DSN=’SalesDB’ :
USER=’admin’,’secret’ : QUERY=’SELECT orderId,
productName, salesDate , countItems, valuePerItem FROM sales WHERE
salesDate>CURRENT_DATE-DAYS 7’))
S WHERE S.productName = P.productName

In the above SQL statement, the ODBCQueryReader function may represent a TVUDF belonging to the TVUDFRegular subclass type. The ODBCQueryReader function is used with appropriate parameters to retrieve rows from an external database. The parameters used for the TVUDF consist of database access information, such as the ODBC connectivity string, database user login name and password, and a query for executing in and fetching data from the external database. The query processed in the external database indicates that it is a partial extraction of data for the past seven days for an incremental data load into the database table “sales”. In some cases, all of the rows from a table are retrieved from an external data source for populating a newly created table in a database.

The above query example demonstrates a number of advantages that may be gained using the data loading techniques described herein. For example, the query shows that a TVUDF in a SQL statement may allow external data to be accessed directly from the external data source for loading rows into a database table, rather than first retrieving the data and then cleansing, transforming, and/or storing the data in a file for a data loading utility to then perform the data loading operation in the database. Instead, when data are to be cleansed and transformed using a TVUDF, the logic can be embedded directly in the TVUDF itself for dynamic and efficient data cleansing and transformation. For example, in the above example INSERT statement, the product names are transformed into product identifiers in the SQL statement itself at the time of data loading.

Another advantage of using a TVUDF in the INSERT statement is that the data to be loaded may flow through the network only once, directly from the external data source to the data loading database. This not only accomplishes efficient data loading, but also avoids undue delays (e.g., due to latency, response times, etc.) in data loading. Yet another advantage of using TVUDFs for data loading is that the data may not undergo any costly data transformations (e.g., from binary to CSV, and than back to binary). Rather, using TVUDFs, data may be retrieved in binary format and loaded directly in the database table in binary format. Furthermore, since the data are loaded directly from the external data source into the database tables, data loading using TVUDFs may alleviate any data governance and security issues associated with sensitive data because the data may be extracted from a secure external source and loaded directly into a secure database environment without intermediate storage in separate, potentially unsecure files. These and other possible benefits and advantages will be apparent from the description herein.

TVUDFs are designed for returning rows with dimension (key), measure and other descriptive fields from external data sources into a SQL statement for data processing. In a SELECT statement, TVUDFs are placed in the FROM clause similar to local database table references. This allows for data from external data sources being processed along with data from local database tables using relational set processing operators as in the example given above. It is important to note that TVUDFs may return rows of data that contain dimension or key fields that participate in relational set processing operations such as join or union with dimension fields from other external as well as local tables. When dimension fields from external sources do not match the dimension fields from the local database tables, transformation of the dimension fields from the external data sources may be implemented using lookup from local tables or other external tables retrieved using TVUDFs. Thus, TVUDFs may be used in federated data processing in SQL databases and the example shown above uses a federated data processing approach to data loading using dimension field transformation by local table lookup.

The basic syntax for user defined functions in a SQL statement can be standardized to pass a set of input field arguments and a set of parameter fields, and return a set of output result fields regardless of the class and/or subclass type of the UDF. The input, parameter, and output fields can be defined as optional to handle user defined functions without input arguments and parameter fields, and with default output result fields. Output fields that are defined as default fields in the output metadata 69 of a user defined function are returned when the output fields are not mapped explicitly in a SQL statement. User defined functions that return table valued rows are, therefore, semantically validated by the compiler by retrieving the class type of the UDF which is one of the TVUDF subclass types. When the syntax of the user defined function specification in a SQL statement is standardized, all the user defined function class types may be parsed in a similar manner at the parser 74, and the class type or subclass type of the UDF may be used by the SQL compiler 62 for resolving and validating the user defined function specification in the SQL statement. One example of such a standardized syntax of a user defined function specification as used in the example SQL statement given above can include the following representation:

<UDF name> ([<Input Expression List>]) [OUTPUT(<Output Expression
List>)] [[WITH] PARAMETER (<key=valueExpression>[:...])]

In the above example UDF specification, items within brackets (e.g., input arguments, output fields, and parameters) are optional; items within parentheses are mandatory; and items within chevrons (< >) are to be replaced with appropriate expressions. The names of the user defined functions are unique and are case-insensitive. The user defined functions may support varying numbers of input and output fields that are composed as table objects at function execution time. The various expression lists can include a series of comma separated items. The input expression list, if present, can include columns or expressions composed using columns from query table.

A mapping for the output of the user defined function is provided using the keyword OUTPUT, with the output expression list including one or more output fields or expressions composed from output field names from the user defined function. Output fields are field names from the user defined function output metadata or field position identifiers, and may use the “$#” syntax, where $ represents a special key character and # represents an ordinal number of the output field, in left to right order starting from one to the total number of N fields. When the output is not explicitly mapped in a SQL statement, default output fields defined in the metadata 69 of the user defined function can be returned.

Input and output fields can be defined as variable fields in a user defined function. A variable field is defined as a field that represents one or more fields at query processing time. Variable fields generate zero or more number of variant fields according to the usage of the user defined function in the SQL statement. A variable field has a base name, and at the time of compiling the SQL statement, the variable fields expand into one or more variant fields according to the user defined function specification in the SQL statement. When variable output fields are involved, they can be mapped in the UDF specification of a SQL statement by appending the base name of the output field with a number starting from an order number of one to a maximum order number of N from left to right where N is the maximum variant fields allowed for the variable field.

Parameters may be provided using WITH PARAMETER syntax, e.g., “key=valueExpression”, and may be separated by colon. The “key” is the parameter field name in the user defined function parameter metadata. The “valueExpression” may be a constant or an expression that evaluates to a constant at compile time. The parameters defined in the expression can include, for example, dates, times, time-stamps, integers, decimal values (e.g., float, double, or long double values), character strings, or comma separated array constants formed from one of these data types.

The “ODBCQueryReader” TVUDF shown in the INSERT statement example has metadata 69 as a part of its code implementation that describes it as a TVUDFRegular subclass type. The SQL compiler 62 of the database retrieves the metadata 69 of the TVUDF and identifies it as a TVUDFRegular subclass type of the TVUDF class. This validates the use of the TVUDF in the FROM clause of a SELECT statement or in other places of a SQL statement where a table can be specified. The subclass type of a TVUDF is used by the SQL compiler 62 to validate the semantic correctness of using it in a SQL statement and to resolve the parameters and output fields in the query. The SQL compiler 62 also uses the subclass type for generating the appropriate data processing plan. The class and/or subclass type of a UDF, thus, may be used by the SQL compiler 62 to resolve and validate semantically the correct usage of the TVUDF at the time of compiling the SQL statement, and to generate an appropriate processing plan.

When tables are normalized, fact tables in a data warehouse may have dimension field identifiers that, by foreign key referencing, indirectly point to field names in dimension tables. When data are retrieved from external data sources for loading, keys may be provided as dimension field names and not as dimension key identifiers. Therefore, dimension field names in the input data for loading may be transformed into dimension field identifiers for storing, particularly in fact tables as in the INSERT/SELECT statement given before. INSERT/SELECT statements are well-suited for data transformations used in data loading, particularly for transforming dimension field names to dimension field identifiers in the database.

There are many data loading scenarios where additional fields, e.g., from other data tables, are added at the time of inserting rows into tables. For example, when a shopping cart UDF, ShoppingCart, returns the number of items sold for a product, the total value of sales can be computed in the SELECT part of the data loading INSERT/SELECT statement using the price per item retrieved from the price table in the local database as in the following data loading statement:

INSERT INTO cartSales(timeOfSales, productId, countItems,
totalSalesValue) SELECT S.timeOfSales, P.productId, S.countItems,
S.countItems * R.pricePerItem AS totalSalesValue FROM price R,
product P, (ShoppingCart( ) OUTPUT(timeOfSales, productName,
countItems) WITH PARAMETER(WEB_SITE=‘https://www.<shopping
web-site address>.’)) S WHERE S.productName = P.productName
AND P.productId = R.productId

When the external data sources have identical row schema with respect to table fields used in data loading, data can be retrieved from external data sources and stored directly in the tables as in the example data loading SQL statement given below:

INSERT INTO sales (orderId, productId, salesDate, countItems,
salesValuePerItem) SELECT * FROM ODBCQueryReader( )
OUTPUT(orderId, productId, salesDate , countItems, salesValuePerItem)
WITH PARAMETER(ODBC_DSN=’SalesDB’ :
USER=’admin’,’secret’ : QUERY=‘SELECT orderId,
productId, salesDate , countItems, salesValuePerItem FROM sales
WHERE salesDate>CURRENT_DATE-DAYS 7’)

When data rows returned from a TVUDF are similar to the field structure of the table in the INSERT statement, rows can be directly loaded into the table in the INSERT statement if the syntax for the INSERT statement is extended. For example, many databases support the INSERT statement to supply data as values using the VALUES syntax or as a SELECT statement. When data are supplied to the INSERT statement either as values or as a SELECT statement, the data are similar in structure with respect to key and other fields of the table fields in the INSERT statement. Therefore, it may be possible to extend the syntax of the INSERT statement to accept a TVUDF subclass type of function as one of the input alternatives when a TVUDF returns rows matching the table field structure in the INSERT statement. Extending the INSERT statement with a TVUDF subclass type of function is represented in the following example syntax:

INSERT INTO <table name>[(<column name list>)]
[VALUES(<column value list>)] |
[<SELECT statement>] |
[TVUDF <table valued user defined function specification including
output and parameter mapping>]

In the above syntax, items delimited by “|” represent OR logical separators indicating that only one of the items can be provided in the query. As such, TVUDF is a key word that is followed by the function specification, and may replace either VALUES or SELECT query specifications in an extended INSERT statement.

Introducing TVUDF in the above INSERT syntax may be equivalent to an INSERT/SELECT statement for data loading. Instead of having the TVUDF in the FROM clause of a SELECT statement clause within an INSERT/SELECT, the TVUDF is given directly in the INSERT statement itself. Both of these approaches semantically represent the same specification. However, the simplicity of the TVUDF syntax in the INSERT statement extends the INSERT statement with a data source syntactic element that returns a table structure serving rows for insertion which is semantically equivalent to a SELECT or VALUES statement clause in the INSERT statement. For example, the following:

lNSERT INTO dailyStockData(stockSymbol, timestamp, openPrice,
closePrice, highPrice, lowPrice, dayVolume)
TVUDF WebStockData( ) OUTPUT(symbol, date, open, close, high, low,
volume) WITH PARAMETER(WEB_SITE=’<web
site address for retrieving stock
data>’:STOCK_SYMBOL=’ALL’:DATE_AFTER=DATE(01/01/2011))

is semantically similar to:

INSERT INTO dailyStockData(stockSymbol, timestamp, openPrice,
closePrice, highPrice, lowPrice, dayVolume,)
SELECT * FROM WebStockData( ) OUTPUT(symbol, date, open,
close, high, low, volume) WITH PARAMETER(WEB_SITE=’<web
site address for retrieving stock data>’:
STOCK_SYMBOL = ’ALL’:DATE_AFTER = DATE(01/01/2011))

Including a TVUDF directly in the extended INSERT statement may provide advantages when there are separate computing nodes for processing data storage and SQL statements, e.g., in the case of a massively parallel processing (MPP) cluster database. In databases that have separate processes to execute SQL statements and data storage, the SQL compiler 62 can generate a plan to process a TVUDF in the storage process itself when the TVUDF is given directly in the INSERT statement. For this, the storage process may be enhanced to execute simple INSERT statements with TVUDFs for retrieving rows from the external data sources to load them directly in a table. In some cases, a TVUDFRegular function can be used directly in the INSERT statement if the table is not partitioned or a table is partitioned and the TVUDF returns rows for the specific table partition. In these cases, having a TVUDFRegular subclass type directly in the INSERT statement executed in the storage process could result in performance gains. When a TVUDFRegular is included directly in an INSERT statement that does not return rows matching the partition scheme of a table partition, the compiler may execute the INSERT statement in the process that processes regular SQL statements and not in the storage processor.

The output field format for TVUDFs may depend upon the rows that are being retrieved from the external data source. TVUDFs may have inbuilt metadata 69 for input, output, and parameter fields. The input field metadata for the TVUDFs may be set as empty since TVUDFs do not have any required input fields. The output metadata 69 of a TVUDF may generally be defined to have only one output field that is defined as a variable field with undefined data type.

A validation and resolution utility function is a part of the UDF framework and may be used for validating and resolving the input, output, and parameter fields of the user defined function specification in a SQL statement at compile time with respect to its metadata 69. Such a validation and resolution utility function systematically applies the dependency rules set in the UDF metadata 69 to resolve and validate the input, output, and parameter fields for the UDF in the SQL statement at the time of its compilation. When there is a special purpose validation and resolution utility function for a UDF, it is set in the metadata 69 of the UDF as a function pointer.

Each group of TVUDFs or individual TVUDFs may implement a separate validation and resolution utility function for validating and resolving the output fields of a TVUDF at the time of compiling the SQL statement. For example, a group of TVUDFs that fetch rows from an external database may implement a special purpose validation and resolution utility function that prepares the SQL statement in the external database and resolves the number of variant output fields and the data type for each one of them. For retrieving rows from HADOOP/HDFS, TVUDFs may utilize a field mapping function specific to the data that are retrieved while processing the validation and resolution utility function. For TVUDFs that read rows from CSV or binary files, a format file having description of each field may be implemented for retrieving the rows.

A TVUDF may also be specified without a special purpose validation and resolution utility function. When a special purpose validation and resolution utility function is not defined in the metadata 69 of a TVUDF, the output fields may be explicitly mapped in the TVUDF specification of a SQL statement and passed to the general purpose validation and resolution utility function to resolve and validate the semantic correctness of the TVUDF in the SQL statement. Since the output fields are mapped in the SQL statement, the general purpose validation and resolution utility function is used at the time of compilation that implicitly accepts the correctness of the output fields given and proceeds to validate the parameter fields if given. In such cases, the SQL compiler 62 may use the TVUDF metadata 69 and the null function pointer of the validation and resolution function pointer. When the validation and resolution utility function pointer is set to null in the metadata 69 of the TVUDF, it indicates that the SQL statement must have output field mapping for the TVUDF and the general purpose validation and resolution utility function will be used for the validation and resolution of output fields explicitly mapped in the SQL statement along with the parameter fields.

To explicitly map the output fields for the TVUDF in a query statement, the output field specification of a user defined function in the SQL statement may need to be extended. In the normal case, the output fields are mapped using either the output field names or $# syntax. In the extended syntax, data type and other additional field descriptions may also be added in the syntax of the output field mapping in the SQL statement. For regular UDF output field mapping, the output field names or $# mappings are given. For TVUDFs, the fields are designated with $# syntax followed by comma separated qualifiers such as data type, size, scale, and NULL given within parentheses. For TVUDF output field mappings, a field can be given a new name using the AS qualifier which is followed by a name at the end of a field specification. The following example syntax may be used for explicitly mapping output fields in SQL statements:

<TVUDF Name>( ) OUTPUT(<field Id>[(<data type name>[,size [,scale]
[, NULL]]) [[AS] field alias name]] [,...])

Where output fields, separated by a comma, are mapped within the parentheses following the keyword OUTPUT. When a data field can have null values, the NULL keyword may be used as shown. When the data fields are to be named, the AS keyword may optionally be used. In general, fields may be mapped in any order according to any requirements of the data insertion field order.

When data rows are sorted in the external data source by primary key, there may be a mechanism to indicate that the rows are supplied in sorted order. In OLAP functions, the ORDER BY clause specific to a function may be used for specifying the sorted order of input fields to the processing function. Since TVUDFs are not OLAP functions and do not have input fields, the OLAP windows ORDER BY within OVER clause can be used without conflict to indicate the ordering of output rows. The SQL compiler 62 collects the sort fields from OLAP windows ORDER BY specification in the statement and supplies it to the TVUDF for its use. When ORDER BY is given, TVUDFs may not use the sort specification because ORDER BY clause indicates that the table of data is already sorted in that order in the external data source. Also, when data are retrieved from external databases using a SELECT statement as a parameter, the SELECT statement usually has an ORDER BY clause for retrieving rows in sorted order.

In some cases, the data that are retrieved for loading may need to be in sorted order and the external data source might not be supplying the data in the sorted order. When sorting is to be requested in the TVUDF implementation, the sort order can be specified using SORT BY syntax. When SORT BY syntax is specified, the TVUDF is directed for data sorting. Alternatively, the database itself may sort the data before loading the data into the database table and relieve the TVUDF from data sorting.

An example OLAP ORDER BY clause that can be used in a TVUDF is given below:
OVER(ORDER | SORT BY <field name | $#> [ASC | DESC] [NULLS [FIRST | LAST]][, . . . ])
   Where either one of the ORDER or SORT specification is provided. When ORDER BY is specified, the TVUDF does not perform sorting, as the external data source supplies the data in sorted order. When SORT BY is specified, the TVUDF performs data sorting, as the external data source does not supply the data in sorted order. In some cases, the database may override a SORT BY specification by taking up data sorting in the database itself and not provide the sort specification to the TVUDF.

In some cases, data loading processes may utilize bulk data retrieval particularly when a data source resides in another computing node. Bulk data processing may delegate the preparation of the data buffer to the data source nodes. In such cases, data for loading may be prepared in binary format according to the storage page structure of rows in the target database. Since databases use page buffers to package a number of rows in a buffer, bulk data can be retrieved using the data page format of a database. A page buffer is similar to the physical storage page of a database that packages a number of data rows with row directory for dynamically accessing rows within a page.

In operation, an executing TVUDF in the database may connect with a live remote server process to retrieve the data in page buffers or access the data pages already processed and stored in local files of the data loading database node. Processing data for loading in page buffers may reduce the number of round trips in the network between the database and the external data source node. This, in turn, may result in performance gains irrespective of whether the external data source is in a computer in a remote location or in the local area network. Another reason for performance gain is that the rows are prepared in another computer according to the storage page format of the database that is ready for data page loading in the database.

Rows in binary page format for data loading are usually formatted in the row structure of a table in the database. Rows in page formats used in one database generally cannot be used in another database. Alternatively, an encoding scheme can be used for identifying rows in a page buffer and fields within each row along with their data type and other field descriptors so that rows and fields can be retrieved in a general way from all the databases. However row encoding schemes may be costly for data loading purposes because of additional space needed for encoding and extra CPU cycles used in processing them. As such, for high performance data loading in a database, packaging rows into page buffers in database page formats may be desirable.

When loading data into a table for the first time, packaging rows in table page format in buffers may be desired for high performance loading. When there is a primary key for the table, rows can be sorted by primary key fields in an external computer node and packaged in sorted order in page buffers for table loading. Loading sorted rows in page buffers may result in the efficient building of a primary index. Also, when incoming rows are used for appending pages in existing tables, sorting rows by primary key and packaging in page buffers may improve the efficiency of loading the data. When the rows are packaged without applying any ordering scheme in page buffers, the SQL processing system may retrieve the rows from page buffers and load them in appropriate storage pages according to their primary key of the table. In cluster databases where tables are generally partitioned by primary keys and persisted in many computer storage units, packaging the rows in page format of the database may not significantly improve performance unless the rows are partitioned using a key hashing algorithm used in the database and packaged in separate page buffers for loading in the target table partitions.

For databases that use data compression, rows of data in compressed format can be loaded into data pages. Data compression may allow for packaging a greater number of rows in a page buffer. This, in turn, may reduce the access of a number of pages across the network between the external data source and database. When a TVUDF returns pages of rows, it may be difficult to implement a validation and resolution function in a general way for the user defined function to generate the output field metadata for the rows. Usually, page returning UDFs are implemented for returning only one binary object field of size equivalent to the size of the page buffer of the target database. The general purpose validation and resolution utility function may resolve the output from page returning TVUDFs as having one field of binary object data type, the size of which is equivalent to the page size of the database. For page returning TVUDFs, the SQL compiler 62 may not supply the output fields mapped in the statement or the data sort order in the statement to the TVUDFs. The output field and sort order specifications may only be used by the executor for interpreting the fields in the rows of page buffers returned by the TVUDFs. When the output field mappings do not follow the order in which the rows in the page are returned, the executor may reorganize the fields in the rows according to the output field mapping in the SQL statement and retrieve each field according to the output field mappings. When the TVUDF returns page buffers, the SQL compiler 62 may utilize explicit mapping of fields in the SQL statement to describe the rows in the page buffer as described above. The TVUDF may return one field of size equal to the page buffer size of the database and the SQL compiler 62 may use the explicitly mapped output fields in the SQL statement for the interpretation of rows in the page buffer. Therefore, all the TVUDFs that return page buffers may utilize explicit mapping of all the output fields in the rows in the SQL statement whether all the fields are used or not while processing and loading data. The executor may retrieve the rows from the page buffer with the help of row index in the page buffer when individual rows are processed for data loading. When explicit output field mapping is not given for the TVUDF in the SQL statement, the compiler assumes that the data returned by the TVUDF is similar in order and data types of the table fields in the insert statement.

The TVUDFs that return page buffers are defined using a TVUDF subclass type, namely TVUDFPage, which the SQL compiler 62 uses at the time of compiling the SQL statement that contains the TVUDF. The TVUDFPage subclass type is used by the SQL compiler 62 to generate appropriate data processing plans. When a TVUDF belonging to the TVUDFPage subclass type is given in a SQL statement, the compiler 62 may ensure that the user has explicitly provided output field mapping for rows in the page buffer returned from the TVUDF. At the time of executing the SQL statement, the executor may retrieve the page buffers from the TVUDF and process the rows according to the processing scenarios generated by the compiler 62. The processing scenario may be a direct page load or row load in different storage pages.

When TVUDFRegular and TVUDFPage subclass type of TVUDFs are used in standard SQL statements, the SQL compiler 62 may generate execution plans to execute the TVUDFs only once in the database. In a standard INSERT statement, TVUDFRegular and TVUDFPage subclass type TVUDFs are not meant for concurrent and parallel multiple executions to retrieve rows from multiple data partitions from the external data source to load them in table partitions. When these subclass types are used in standard INSERT statements for loading rows into partitioned tables, the rows retrieved from the TVUDFs are distributed according to the key hash distribution scheme for the table for loading rows into appropriate target table partitions. Therefore, when tables are partitioned and stored in multiple storage units, TVUDFs belonging to the TVUDFPage subclass type may be used for returning a page full of rows and TVUDFRegular may be used for returning one row at a time into the standard INSERT statement executor. The executor may further generate a hash value for each row by using the hash algorithm on primary key fields and distribute rows to the appropriate table partitions for storage.

For high performance data loading, concurrently retrieving data partitions from external data sources and loading data into table partitions of a cluster database may be desired. When the data set from the external data source is available as a single set, concurrent data loading into table partitions may not be possible, and TVUDFRegular and TVUDFPage subclass type of TVUDFs may be used in standard INSERT/SELECT statements for retrieving, distributing, and loading data into the table partitions. However, when the external data source has multiple data partitions in one or more computing nodes for loading into table partitions, a cluster database can load the external data partitions into its table partitions in parallel. When tables in the database are not partitioned, multiple external data partitions from external data sources can be retrieved concurrently in multiple threads or processes in a cluster database and sent for loading in the table storage node.

When tables in the database are partitioned, two scenarios of loading data from external multiple data partitions may be utilized. The first scenario involves data partitions from external data sources when they are not partitioned to match the partition scheme of a partitioned table. Such data partitions are called non-key-hash partitions. In this scenario, the database may retrieve the external data partitions concurrently and distribute the rows according to the key partition scheme of the table for loading them into their respective table partitions. In non-key-hash cases, the number of external data partitions in the external data source need not match the number of table partitions in the cluster database. In general, all of the storage nodes of a table in an MPP cluster database can participate in concurrent data retrieval processing. When the number of partitions is more than the number of storage nodes for the table, the configuration file for retrieving external data partitions in certain nodes will have more than one data partition which the TVUDF may process sequentially. The performance gain, if any, from processing the non-key-hash data partitions may result only from parallel reading of data partitions and data conversions.

In the second scenario, the external data partitions are available similar to the key partition scheme of a partitioned table. These are called the key-hash partitions. In this case, the number of data partitions in the external data source matches the number of table partitions in the cluster database. It may be possible to have multiple fragments of a data partition in the external data source, and such fragments may be treated as a single partition together. In such cases, the retrieving node in the cluster database may retrieve the external data fragments of a partition sequentially for processing and loading from the configuration resource entries for data partitions. Since key-hash partitions can be retrieved directly into the storage nodes, storage nodes can process them directly for loading them into table partitions when the TVUDF is given directly in the INSERT statement. When the rows are not in sorted order, the data loader may retrieve the rows from the TVUDF and load them in the appropriate pages of a table partition.

When data from external data sources are available as non-key-hash partitions for loading into a partitioned table, a cluster database may need to know that there are multiple data partitions so that the SQL compiler can generate the appropriate concurrent and parallel data partition retrieving plan for data loading. For this, the TVUDF in the INSERT statement may be qualified with PARALLEL PARTITION syntax. On seeing the syntax PARALLEL PARTITION for the TVUDF, the SQL compiler may generate a data retrieving plan that retrieves data partitions from external data sources in parallel. Examples of an INSERT statement are given below:

INSERT INTO sales (orderId, productId, salesDate, countItems,
salesValuePerItem) SELECT * FROM PARALLEL PARTITION
ODBCQueryReader( ) OUTPUT(orderId, productId, salesDate ,
countItems, salesValuePerItem) WITH
PARAMETER(CONFIG_FILE=’SalesData’)

### Or:

INSERT INTO sales (orderId, productId, salesDate, countItems,
salesValuePerItem) TVUDF PARALLEL PARTITION
ODBCQueryReader( ) OUTPUT(orderId, productId, salesDate ,
countItems, salesValuePerItem) WITH
PARAMETER(CONFIG_FILE=’SalesData’)

For each data partition from the external data source, there may be a configuration resource that contains the accessing and processing information needed for retrieving the data partition from the external data source. Therefore, for PARALLEL PARTITION processing, there will be multiple configuration resources in multiple processing computer nodes of an MPP cluster database or in the same computer of a symmetric multiprocessing (SMP) database. Each of the configuration resources may have a specific set of information for data accessing and processing as in the example configuration resource given below:

QUERY = SELECT orderId, productId, salesDate , countItems,
salesValuePerItem FROM
sales WHERE salesDate>=1/1/2000 AND salesDate<1/1/2001;
ODBC_DSN = SalesDB;
USER = admin;
PWD = secret;

Each configuration resource, in this example, has one query for retrieving data for one year, for example, starting from year 2000. It is possible to have configuration specification for multiple partitions or multiple fragments within data partitions in a configuration resource. When multiple fragments are involved in data loading, the configuration file may have more than one entry, each entry representing configuration information for one fragment. For example, in the above example configuration file, there may be multiple QUERY=<query> specifications, each representing one fragment data within the same external data source. Alternatively, there could be multiple fragments each coming from a separate data source for which there may be separate entries of all the fields for all the data sources.

In an INSERT statement, TVUDFRegular and TVUDFPage subclass types can be qualified with PARALLEL PARTITION for generating a plan for retrieving data partitions concurrently and in parallel in multiple processing tasks. When parallel partition is used for TVUDFs, they do not require ORDER BY or SORT BY specification as the sort order in the rows retrieved do not follow the key partition scheme used in table partitions in the database. Therefore, if the query has an OLAP ORDER BY or a SORT BY specification for the TVUDF, the compiler may return an error message or ignore it. Similar to loading a single data set from an external data source, the TVUDFRegular subclass type may utilize output field mapping when a special purpose validation and resolution utility function is not built for it. TVUDFPage, as previously explained, may utilize the output field mapping in the statement, and the SQL compiler 62 may not pass the output field mapping to the TVUDF.

When the SQL compiler 62 processes a TVUDF for parallel partition data retrieval, it may generate a plan to process the TVUDF in multiple computer nodes of an MPP cluster database or multiple threads or processes of an SMP cluster database. In order to process a TVUDF for parallel partition retrieval, a configuration resource may be utilized as described above. The TVUDF may first retrieve the configuration resource, and may then use the information for retrieving the data partition. For this, the TVUDF may utilize two pieces of information. First, a parameter field that contains the name for the configuration resource. In some cases, when the user specifies a configuration resource in a parameter field for a TVUDF of an INSERT statement, it is either a single name or an array of names. Second, an identification number to distinguish the configuration resource for one particular external data partition from the other.

When a cluster database processes a parallel partition INSERT statement, it may generate an identification number which is usually the key-hash identification number of the process, thread, or node that executes the TVUDF. The key-hash identification number is identical to the key-hash identification number used for partitioning the table in the insert statement. The identification number may be supplied to the TVUDF via the parameter object. The default identification value in the parameter object may be set to an invalid number, e.g., −1. When the compiler generates the identification number, it may generate the value from 0 to N−1 where N is the total number of partitions in a table. The identification number may identify the configuration resource by indexing into the array of names when the parameter field contains an array of configuration resource names. Or the identification number may be used for concatenating with the parameter field from the SQL statement to generate the configuration resource name for a data partition.

In various implementations, the configuration resource may be a configuration file, a registry key, an LDAP entry, a web address, an environment variable, or another appropriate configuration resource. When the configuration resource is a single file having entries for the various data partitions, the identification number may be used by each processor to retrieve information from the file specific to its data partition. When the TVUDF identifies that the parameter object is not set with a configuration resource identification number, it may simply use the configuration resource name given in the parameter field itself. Therefore, the same TVUDF may be used for single dataset retrieving and data partition retrieving by using the identification number in the parameter object. When the TVUDF identifies a valid identification number, it may use the identification number along with the parameter field to generate the configuration resource name. The configuration resource may contain the access and other processing information needed for retrieving an external data partition.

A configuration resource may contain more than one access information when a TVUDF is configured to retrieve more than one data partition, which the TVUDF may process sequentially in the order specified. The TVUDF may not use the identification number while accessing the configuration resource as in the case of an MPP cluster database where each node can have a configuration resource with the name identical as given in the parameter field without collision with the same name given in other nodes. For example, in a SMP cluster database, the parameter field may contain a string ‘foo’. If there are ten external data partitions, there could be ten configuration files in the same directory such as ‘foo0’, ‘foo1’ to ‘foo9’, with one file having the configuration information for one external data partition. The implementation of TVUDF for generating the configuration resource name and setting up the environment for data loading must match the scheme described for data loading to work correctly. However, in all the cases, a parameter field in the TVUDF specification in the INSERT statement and the compiler generated identification number may be used to generate the configuration resource name in the TVUDF while retrieving external data partitions.

The compiler generally does not know how many data partitions are involved in retrieving external data partitions. The compiler generates a plan for concurrent data loading of multiple external data partitions equal to the number of data partitions of a table. However, the external data source might not have as many numbers of data partitions as the number of processing tasks generated in the plan of the compiler. When a TVUDF is executed for data partition retrieval, if the TVUDF does not see a configuration resource using the name in the parameter field and the compiler generated identification number, processing of the TVUDF may exit. Only the TVUDFs that are associated with matching configuration resources may proceed to retrieve data from the external data partitions. When the number of external partitions is more than the number of table partitions, certain configuration resources will have more than one data partition information. When tables are not partitioned, multiple external partitions can be loaded concurrently into the table by executing multiple standard INSERT statements with TVUDFs and, therefore, parallel partition insert statements should generally not be used. When parallel data loading is used for tables that are not partitioned, the compiler may generate an error message.

When external data are partitioned similar to table partitions using the same key hash algorithm the database uses, each data partition in the external data source may have a corresponding table partition for data loading. For this, the TVUDF may be qualified with PARALLEL KEY PARTITION syntax in the INSERT statement as below:

INSERT INTO sales (employeeName, address, dateOfBirth, SSN,
education, dateOfJoining, designation, baseAnnualSalary)
SELECT * FROM PARALLEL KEY PARTITION ODBCQueryReader( )
OUTPUT(employeeName, address, dateOfBirth, SSN, education,
dateOfJoining, designation, baseAnnualSalary) WITH
PARAMETER(CONFIG_FILE=’EmployeeData’)

### Or:

INSERT INTO sales (employeeName, address, dateOfBirth, SSN,
education, dateOfJoining, designation, baseAnnualSalary)
TVUDF PARALLEL KEY PARTITION ODBCQueryReader( )
OUTPUT(employeeName, address, dateOfBirth, SSN, education,
dateOfJoining, designation, baseAnnualSalary)
WITH PARAMETER(CONFIG_FILE=’EmployeeData’)

When TVUDFRegular and TVUDFPage subclass types of TVUDFs are qualified with PARALLEL KEY PARTITION syntax for data loading, the compiler may generate a plan to load the data from each external data partition into its respective table partition. Data loading using PARALLEL KEY PARTITION syntax may be used only when the tables are partitioned and the external data are partitioned similar to the key partition scheme of table partitions. When PARALLEL KEY PARTITION syntax for data loading is used for tables that are not partitioned, the compiler may return an error message. In some cases, a single data partition can be available in multiple fragments and, in such cases, all the fragments of the data partition must be presented in a single configuration resource which the TVUDF uses one after another for data retrieval.

For both of the TVUDF subclass types, the OLAP ORDER BY clause may be supplied when data in each partition are sorted, and the SORT BY clause may be provided when the data are not in sorted order. For TVUDFRegular subclass types, the database can setup data sorting in the TVUDF when the data are not sorted. The database may also take over data sorting and sort the data before loading the rows in the table partition. In implementations, setting the data order specification using either ORDER BY or SORT BY may be made mandatory so that the compiler can validate if the data order matches the primary key fields of the table.

Data loading using PARALLEL KEY PARTITION syntax for a TVUDF may utilize a configuration resource similar to the configuration resource described for parallel partition data loading described above. The SQL compiler 62 may generate a concurrent data loading plan that consists of a number of processing tasks equal to the number of partitions in the table. In an MPP cluster database, the data loading plan may be executed in the nodes where the data storage unit for the data partition resides and, therefore, configuration resources must be available at these nodes.

The TVUDFs described above involve retrieving data from external data sources. There is another scenario for data loading that the external data source could send data to executing TVUDFs in the database. For example, in HADOOP map/reduce processing, the processed data could be loaded directly into the database tables instead of storing in HADOOP distributed file system (HDFS). For this, execution of map/reduce in HADOOP and TVUDF in the database may be synchronized. In one scenario, the reduce function in HADOOP can be implemented as a server for the TVUDF to connect. In some implementations, the HADOOP reduce function opens an IP address and waits for the connection from TVUDF to be made. In other implementations, the TVUDF opens an IP address and waits for the reduce function to make the connection. In either case, TVUDF and the reducer receive a timeout period within which communication are to be established between the reduce function in HADOOP and the TVUDF in the database. If communication does not take place within the timeout period, programs on either side exit. Also, at the end of processing, the external data source may indicate the end of data processing for ending data loading. This type of data processing may be done with the help of an external scheduling program that initiates the processes in the external data source and in the database with timeout periods. This approach can be used for single table data loading or partition table data loading with or without key partitions without intermediate data storage anywhere.

The subclass types of TVUDF (TVUDFRegular and TVUDFPage) as described above are associated with on-demand data retrieval from external data sources. When these TVUDFs finish retrieving data from the target data sources, data loading comes to an end, and the INSERT statement returns. The CLTVUDF subclass types described below are associated with continuous data loading of data that is received from one or more client processes from the same or different computer nodes.

One example use case for continuous data loading is data from an online transaction processing (OLTP) system. OTLP systems are typically connected with client applications, and their data are continuously loaded as the client applications provide data. Data warehouse systems may receive data from various sources, such as from OLTP systems as well as from other external structured and unstructured data sources. Such external data may need further processing to generate the row structure of tables in the data warehouse. For this, data may be periodically retrieved from the source locations and processed to the row structure of tables in the data warehouse. With ever expanding data sources (e.g., live enterprise applications, sensors, and web-page click streams) that may require continuous activity and performance monitoring and analytical processing in an operational environment, data warehouses may be used to support decision making processes. Therefore, operational data warehouses may integrate continuous data loading to support operational decision-making applications.

Three examples of implementing CLTVUDFs are identified below. In a first example, CLTVUDFs can be implemented as clients waiting on a message queue server for the arrival of data. When message queue servers are used, client processes send (publish) their data in a named message queue from any computing node, and CLTVUDFs subscribe to the named message queue for receiving data. In the second example, CLTVUDFs can be implemented as a server process, such as a TOP server process, waiting for clients to connect and send data for loading. In this case, clients can connect, send data, and disconnect or remain connected for long durations. But the CLTVUDF may continuously wait for new clients to connect or connected clients to send data. In the third example. CLTVUDFs can be implemented for periodic polling at an external data source server process to determine if data are ready for processing. When polling returns with data available for processing, the data are retrieved and loaded. In all the three examples of continuous data processing, the longevity of the executing CLTVUDFs in the system is longer than the execution of a typical on-demand TVUDF in a standard INSERT statement.

For continuous data loading in a database, CLTVUDFs are used in the INSERT statement. As described before, they are CLTVUDFRegular and CLTVUDFPage subclass types. The description of these subclass types is similar to the corresponding data retrieving TVUDF subclass types described before. The only difference being that the CLTVUDF subclass types are implemented to receive data from external processes directly or through message queue servers or as a polling system to peek for data readiness at the external data sources for retrieving.

Similar to the TVUDFRegular subclass type, the CLTVUDFRegular subclass type returns one row at a time for processing. When a special validation and resolution utility function is not built for the CLTVUDFRegular subclass type functions, the output fields are explicitly mapped in the SQL statement itself which is similar to TVUDFRegular subclass type without special validation and resolution utility functions. CLTVUDFPage subclass type returns a page full of rows at a time. CLTVUDFPage requires output fields explicitly mapped in the SQL statement which is similar to TVUDFPage subclass type. Data order specification for CLTVUDF subclass types may not be required because usually sorting requires that all the data are supplied and CLTVUDFs do not supply all the data together. Data sorting could be used when data set are retrieved periodically in bulk so that they can be sorted and loaded. When sorting is needed, it is specified using the OLAP ORDER or SORT specification described before.

CLTVUDFs that process data partitions may use configuration resources similar to PARALLEL PARTITION and PARALLEL KEY PARTITION TVUDFs described before. While data partition processing TVUDFs may utilize data accessing information for external data sources in the configuration resources, data partition processing CLTVUDFs may utilize a port number to listen to, or a message queue service name and the connection information for a message queue server, or an IP address and a port number to poll for data availability information in configuration resources. Similar to the data partition processing TVUDFs, data partition processing CLTVUDFs may utilize a key hash identification number from the compiler and a parameter field for selecting the appropriate configuration resource. Similar to data partition processing TVUDFs, data partition processing CLTVUDFs are qualified with syntax PARALLEL PARTITION for non-key hash data processing and PARALLEL KEY PARTITION for key hash data processing.

CLTVUDF subclass types may be used for continuous data loading by executing them in a background process for bringing data into the database for continuous data loading. While TVUDFs exit when the end of data is reached, CLTVUDFs may execute continuously, even when a client disconnects. When a CLTVUDF is implemented as a TCP server process, many external data source clients can make connections, send data, and exit while the CLTVUDF continues to wait for new clients to connect and send data.

The INSERT statement that contains the CLTVUDF is run in the database as a background process for continuously bringing data into the database for data loading. In order to communicate to the SQL compiler 62 that the data load processing is done in the background without connection to the external client process that initiated the INSERT statement, the following extension to the INSERT statement may be used:

CONTINOUS <unique name identifier> INSERT <insert statement
as described for TVUDF>

The SQL compiler 62 verifies the INSERT statement if it is using a CLTVUDF in the statement. If the INSERT statement does not use a CLTVUDF, the compiler may return an error message. If an INSERT statement uses a CLTVUDF, the compiler may set up the statement for continuous data loading in a background process which is reachable using the unique name identifier given in the continuous processing INSERT statement. If the unique name identifier is already used by another continuous data loading statement, the SQL compiler 62 may return an error message. When CLTVUDFs are used for parallel partition and parallel key partition data loading in a SQL statement the compiler may set up data loading in all the table partition processing tasks of a cluster database similar to the TVUDF parallel partition and parallel key partition data loading.

Having a unique name identifier for the continuously data loading INSERT statement is important for managing the background process from an external application. By using the unique identifier name, an external program can request the database to supply the detailed information for specified continuous data loading INSERT statements using the following SQL command:

SHOW CONTINUOUS INSERT <unique name identifier [, . . . ]>

The list of unique name identifiers for all the continuously processing INSERT statements can be retrieved from the database using the following SQL command:

SHOW CONTINUOUS INSERT ALL

Also, when continuous data load processing is not required, specific background data loading programs can be terminated using the following SQL command:

DROP CONTINOUS INSERT <unique name identifier[, . . . ]>

When all the continuous insert processing background processes are to be terminated, the following SQL command can be executed:

DROP CONTINOUS INSERT ALL

Continuous data loading operations may be utilized in operational data warehouses that endeavor to keep data current and as dose to real time as possible for supporting activity and performance monitoring applications. For database applications in the areas of, for example, automated manufacturing, inventory management, sales management, advertisement campaign management, and operational cash flow management, continuous data processing operational data warehouses could play a central role. Continuously data loading features described herein may simplify the tasks of initiating, managing, and monitoring continuous data loading INSERT statements in a database.

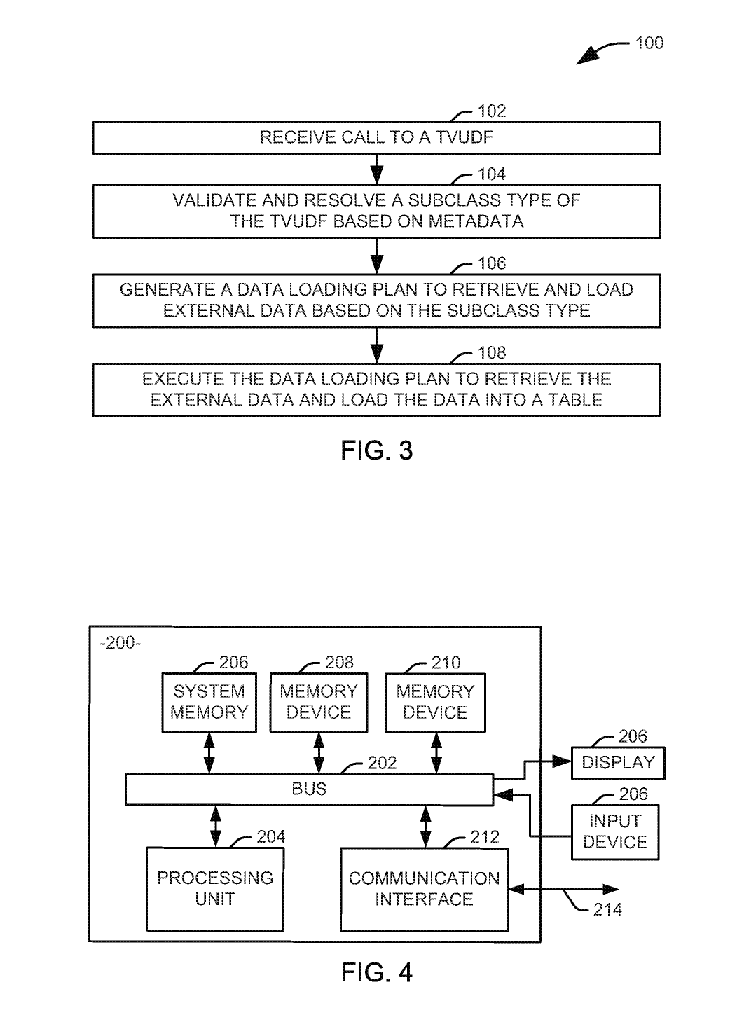

FIG. 3 illustrates an example process 100 for data loading with a user defined function. The process 300 may be performed, for example, by one or more components of a data processing system, such as the data processing system 10 illustrated in FIG. 1. However, it should be understood that another system, or combination of systems, may be used to perform the process or various portions of the process.

At block 102, a call to a table valued user defined function is received. At block 104, a subclass type of the table valued user defined function is validated and resolved based on the metadata associated with the function. At block 106, a data loading plan to retrieve and load external data is generated based on the subclass type of the table valued user defined function. The data loading plan includes the table valued user defined function. At block 108, the data loading plan is executed to retrieve the external data and load the retrieved data into an appropriate table of the database in accordance with the data loading plan.

FIG. 4 is a schematic block diagram illustrating an example system 200 of hardware components capable of implementing examples of the systems and methods for data loading with user defined functions illustrated in FIGS. 1-3. The system 200 can include various systems and subsystems. The system 200 can be a personal computer, a laptop computer, a workstation, a computer system, an appliance, an application-specific integrated circuit (ASIC), a server, a server blade center, a server farm, or any other appropriate processing component.

The system 200 can include a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand alone database, or other non-volatile memory, can also be in communication with the system bus 202. The system bus 202 operably interconnects the processing unit 204, the memory devices 206-210, the communication interface 212, the display 216, and the input device 218. In some examples, the system bus 202 also operably interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core.

The system memory 206 and/or the memory devices 208, 210 can store data, programs, instructions, database queries in text or compiled form, and other appropriate information that may be needed to operate a computer. The memories 206, 208, and 210 can be implemented as computer-readable media (integrated or removable) such as a memory card, disk drive, compact disk (CD), or server accessible over a network. In certain examples, the memories 206, 208, and 210 can comprise text, images, video, and/or audio.

Memory devices 208 and 210 can serve as databases or data storage. Additionally or alternatively, the system 200 can access an external data source or query source through the communication interface 212, which can communicate with the system bus 202 and the communication link 214.

In operation, the system 200 can be used to implement the various techniques described above. Computer executable logic for implementing the data loading system may reside on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium, such as a non-transitory storage medium, that participates in providing instructions to the processing unit 204 for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A system for data loading comprising:
a structured query language (SQL) compiler to identify a call to a table valued user defined function within a SQL statement that includes an insert statement, identify metadata associated with the table valued user defined function, validate and resolve a subclass type of the table valued user defined function based on the metadata and the insert statement, and generate a data loading plan to retrieve and load data from an external data source into a table of a loading database based on the subclass type of the table valued user defined function; and
a data loading engine in the loading database to execute the data loading plan generated by the SQL compiler, the data loading plan including the table valued user defined function to retrieve data from the external data source, and load the retrieved data into the table of the loading database in accordance with the data loading plan.

2. The system of claim 1, wherein the data loading plan executes in an on-demand manner when the insert statement comprises an on-demand data loading insert statement.

3. The system of claim 1, wherein the data loading plan executes in a continuous manner when the insert statement comprises a continuously loading insert statement.

4. The system of claim 3, wherein the data loading plan indicates that the data are being loaded continuously in a background process having a name identifier in the loading database, and wherein management and monitoring of the background process are based on the name identifier.

5. The system of claim 1, wherein the SQL compiler returns an error in response to the call to the table valued user defined function being used outside of a FROM clause of a SELECT statement or an INSERT statement with extended syntax.

6. The system of claim 1, wherein the SQL compiler determines a number of data partitions in the external data source and a number of partitions in the table of the loading database, and wherein the data loading plan is based on the determined number of data partitions in the external data source and the number of partitions in the table of the loading database.

7. The system of claim 6, wherein the data loading plan indicates that an identification number from the SQL compiler is required for the table valued user defined function to obtain a configuration resource to process each of the data partitions.

8. The system of claim 6, wherein the data loading plan comprises collecting data in parallel from the external data source for loading in the partitions in the table of the loading database.

9. The system of claim 1, wherein the data loading plan indicates that the table valued user defined function processes a row of data at a time.

10. The system of claim 1, wherein the data loading plan indicates that the table valued user defined function processes a page of data at a time.

11. The system of claim 1, wherein the data loading plan includes an output field mapping of the retrieved data.

12. The system of claim 1, wherein the data loading plan indicates that the table valued user defined function retrieves the data in sorted order.

13. The system of claim 1, wherein the data loading plan indicates that the table valued user defined function executes in the data storage computer node.

14. A computer-implemented method for data loading, the method comprising:
receiving, at a computing device, a call to a table valued user defined function within a structured query language (SQL) statement that includes an insert statement;
processing the call, using the computing device, to validate and resolve a subclass type of the table valued user defined function based on metadata associated with the table valued user defined function; and
generating, using the computing device, a data loading plan to retrieve and load data from a data source that is external to the computing device based on the subclass type of the table valued user defined function, the data loading plan including the table valued user defined function; and
executing, using the computing device, the data loading plan to retrieve the data and load the retrieved data into a table in accordance with the data loading plan.

15. A non-transitory computer-readable storage medium Storing instructions that, when executed by a processor, cause the processor to:
receive a call to a table valued user defined function within a structured query language (SQL) statement that includes an insert statement;
process the call to validate and resolve a subclass type of the table valued user defined function based on metadata associated with the table valued user defined function; and
generate a data loading plan to retrieve and load data from an external data source based on the subclass type of the table valued user defined function, the data loading plan including the table valued user defined function; and
execute the data loading plan to retrieve the data and load the retrieved data into a table in accordance with the data loading plan.
